(19) United States
(12) Patent Application Publication
(10) Pub. No.: US 2024/0151263 A1
(43) Pub. Date: May 9, 2024

(54) BALL SOCKET ASSEMBLY AND METHOD OF MAKING

(71) Applicant: Federal-Mogul Motorparts LLC, Northville, MI (US)

(72) Inventor: Pawel Mleczko, Northville, MI (US)

(21) Appl. No.: 18/385,531

(22) Filed: Oct. 31, 2023

Related U.S. Application Data
(60) Provisional application No. 63/422,259, filed on Nov. 3, 2022.

(51) Int. Cl. F16C 11/06

(52) U.S. Cl. CPC F16C 11/0633; F16C 11/0604; F16C 2208/02; F16C 2208/32; F16C 2208/66

(57) ABSTRACT

The ball socket assembly includes a housing with an inner bore and a bearing that is received in the inner bore of the housing. The bearing is made as a monolithic piece of a plastic material and has a curved bearing surface which surrounds a ball cavity. A ball stud, which has a ball portion and a shank portion, is received in the ball cavity of the bearing. The ball portion has an equator. The curved bearing surface of the bearing is in slidable contact with the ball portion of the ball stud on opposite axial sides of the equator. The plastic material of the bearing comprises 8-12 mass percent polytetrafluoroethylene, 2-6 mass percent carbon fibers, and the remainder acetal. The ball stud having a hardened layer along at least a portion of its outer surface, the hardened layer being a Nitrox layer.

### CROSS-REFERENCE TO RELATED APPLICATION

This application claims priority to U.S. Provisional Application No. 63/422,259, filed on Nov. 3, 2022 and entitled “BALL SOCKET ASSEMBLY AND METHOD OF MAKING.”

### BACKGROUND OF THE INVENTION

### 1. Field of the Invention

The present invention is related generally to ball socket assemblies and more particularly to a ball socket assembly with a bearing that is made of a monolithic piece of a plastic material.

### 2. Related Art

Vehicle suspension and steering systems typically include a number of ball joints which fixedly attach various components while allowing relative rotation and articulation between those components. A ball joint generally has a housing, a ball stud, and one or more bearings. In ball joints with a single bearing, where the bearing is made as a monolithic piece, it must be constructed in such a way that the ball stud can be inserted into the bearing without fracturing, or otherwise breaking the bearing. One approach to solving this problem is to make the bearing out of a material that has a high elasticity so that the bearing can deform elastically when the ball stud is inserted into a ball cavity of the bearing.

### SUMMARY

An aspect of the present disclosure is related to a ball socket assembly that includes a housing with an inner bore. The ball socket assembly also includes a bearing that is received in the inner bore of the housing. The bearing is made as a monolithic piece of a plastic material and has a curved bearing surface which surrounds a ball cavity. A ball stud, which has a ball portion and a shank portion, is received in the ball cavity of the bearing. The ball portion has an equator. The curved bearing surface of the bearing is in slidable contact with the ball portion of the ball stud on opposite axial sides of the equator. The plastic material of the bearing comprises 8-12 mass percent polytetrafluoroethylene, 2-6 mass percent carbon fibers, and the remainder acetal. The ball stud having a hardened layer along at least a portion of its outer surface, the hardened layer being a Nitrox layer.

According to another aspect of the present disclosure, an entire outer surface of the ball stud includes the hardened layer.

According to yet another embodiment of the present disclosure, the ball stud includes a base material that is of an SAE-AISI 4140 steel or an SAE-AISI 5140 steel.

According to still another aspect of the present disclosure, the hardened layer includes an oxide zone and a compound zone.

According to a further aspect of the present disclosure, the oxide zone of the hardened layer has a thickness that is in the range of 2-3 μm.

According to yet a further aspect of the present disclosure, the compound zone of the hardened layer has a thickness in the range of 24-28 μm.

According to still a further aspect of the present disclosure, the bearing includes a plurality of fingers that are spaced apart from one another by a plurality of slots. The fingers can flex outwardly when inserting the ball portion of the ball stud into a ball cavity of the bearing.

According to another aspect of the present disclosure, the bearing surface of the bearing is in contact with both an upper hemisphere and a lower hemisphere of the ball portion of the ball stud.

According to yet another aspect of the present disclosure, the bearing includes a recessed area.

Another aspect of the present disclosure is related to a method of making a ball socket assembly. The method includes the step of forming a ball stud out of metal, the ball stud having a ball portion and a shank portion. The method continues with the step of applying a Nitride layer to at least a portion of an outer surface of the ball stud. The method proceeds with the step of forming a bearing that has a curved bearing surface of a plastic material that comprises 8-12 mass percent polytetrafluoroethylene, 2-6 mass percent carbon fibers, and the remainder acetal. The method continues with the step of inserting the bearing and the ball stud into a housing with an outer surface of the ball stud being in slidable contact with the curved bearing surface of the bearing.

According to another aspect of the present disclosure, the step of applying the Nitrox layer to the ball stud includes subjecting the ball stud to a gas nitriding operation to form a compound zone and then subjecting the ball stud to an oxidation process to form an oxide zone.

According to yet another aspect of the present disclosure, the compound zone of the Nitride layer has a thickness in the range of 24-28 μm.

According to still another aspect of the present disclosure, the oxide zone of the Nitride layer has a thickness in the range of 2-3 μm.

According to a further aspect of the present disclosure, the step of applying the Nitrox layer to the ball stud includes applying the Nitrox layer to an entire outer surface of the ball stud.

According to yet a further aspect of the present disclosure, the bearing includes a plurality of fingers that surround a ball cavity and are spaced apart from one another by a plurality of slots that extend form an open end of the bearing.

According to still a further aspect of the present disclosure, the method further includes the step of deflecting the fingers of the bearing while inserting the ball portion of the ball stud into the ball cavity of the bearing.

According to another aspect of the present disclosure, the curved bearing surface of the bearing is in slidable contact with an upper hemisphere of the ball portion of the ball stud and a lower hemisphere of the ball portion of the ball stud.

According to yet another aspect of the present disclosure, the metal of the ball stud is SAE-AISI 4140 steel or is SAE-AISI 5140 steel.

Yet another aspect of the present disclosure is related to a method of making a ball socket assembly. The method includes the step of forming a ball stud out of SAE-AISI 4140 steel or SAE-AISI 5140 steel. The ball stud has a ball portion and a shank portion. The method further includes the step of subjecting the ball stud to a gas nitration operation in an oven to create a zone in the ball stud that has dissolved nitrogen and hard nitrogen precipitates. The method proceeds with the step of subjecting the ball stud to an oxidation process to form a zone in the ball stud that has Fe₃O₄. The method continues with the step of forming a bearing that has a curved bearing surface of a plastic material that comprises 8-12 mass percent polytetrafluoroethylene, 2-6 mass percent carbon fibers, and the remainder acetal. The method proceeds with the step of inserting the bearing and a portion of the ball stud into a housing with an outer surface of the ball stud being in slidable contact with the curved bearing surface of the bearing.

According to another aspect of the present disclosure, the oven is set at a temperature of between five hundred and five hundred and fifty degrees Celsius (500-550° C.).

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective elevation view of an exemplary embodiment of a socket assembly constructed according to one aspect of the present invention;

FIG. 2 is a partially cross-sectional view of the socket assembly of FIG. 1;

FIG. 3 is an exploded and partially cross-sectional view of the socket assembly of FIG. 1;

FIG. 4 is a perspective elevation view of a bearing of the socket assembly of FIG. 1;

FIG. 5A shows the bearing of FIG. 4 in cross-section and a ball stud in a pre-assembled condition;

FIG. 5B shows the ball stud during assembly with the bearing;

FIG. 5C shows the ball stud as being assembled with the bearing;

FIG. 6 is a cross-sectional and magnified view of a portion of the ball stud of the exemplary embodiment of the socket assembly and illustrating an FNC layer;

FIG. 7 is a perspective elevation view of a ball socket assembly constructed according to a second embodiment of the present disclosure;

FIG. 8 is a cross-sectional view of a ball stud of the second exemplary embodiment of the ball socket assembly;

FIG. 9 is a cross-sectional view of a bearing of the second embodiment of the ball socket assembly; and

FIG. 10 is a perspective view of the bearing of FIG. 9.

### DESCRIPTION OF THE ENABLING EMBODIMENTS

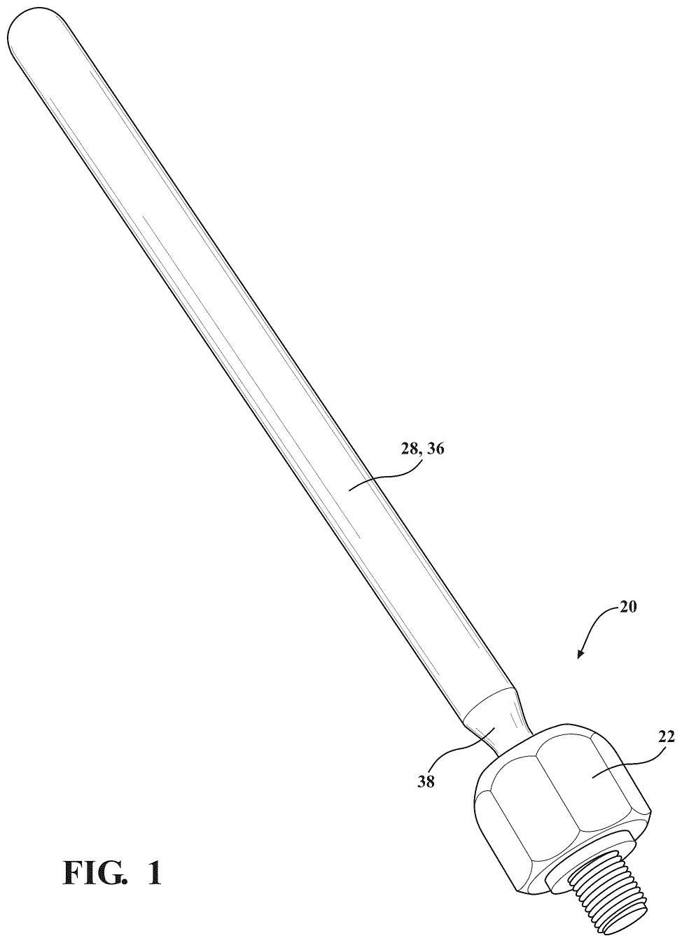

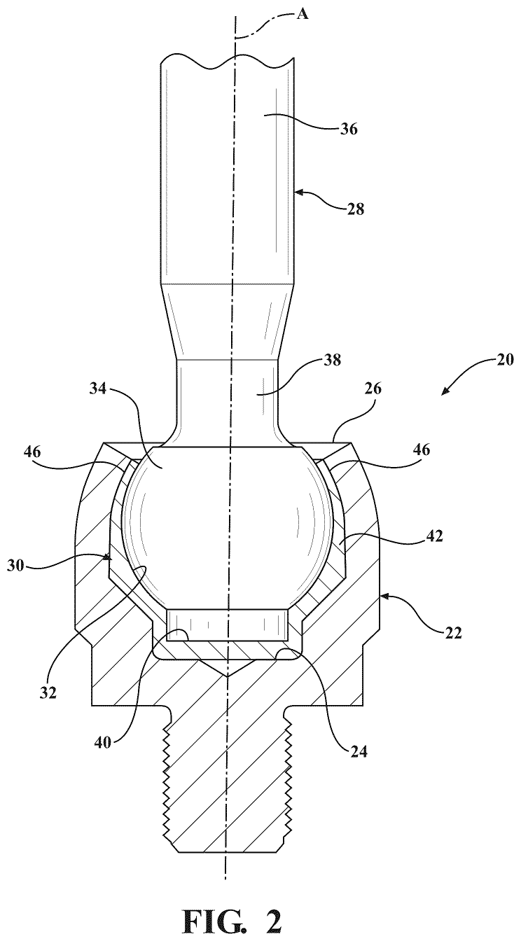

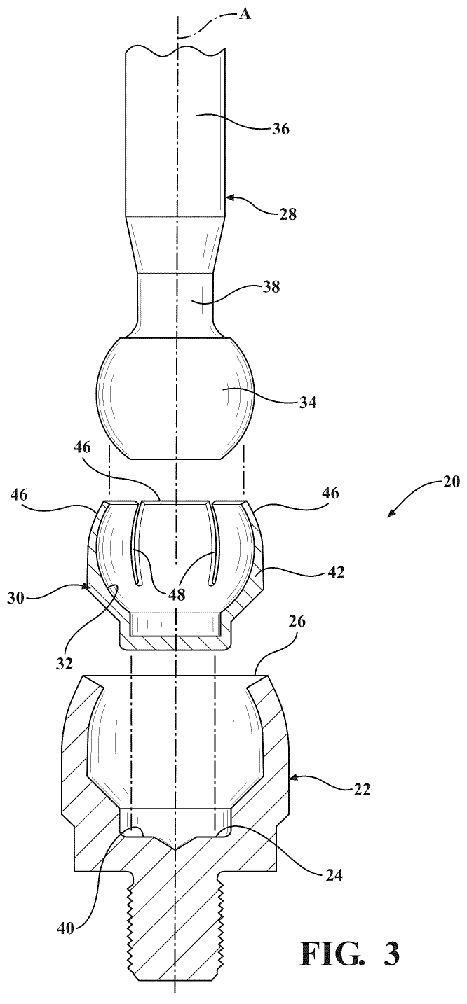

Referring to FIGS. 1-3, wherein like numerals indicate corresponding parts throughout the several views, a first exemplary embodiment of a ball socket assembly 20 for a vehicle steering system is generally shown. In the exemplary embodiment, the ball socket assembly 20 is an inner tie rod end. However, it should be appreciated that the ball socket assembly 20 could find other automotive or non-automotive applications. For example, the ball socket assembly 20 could be a ball joint for connecting a control arm with a knuckle or an outer tie rod end in a vehicle suspension system.

The ball socket assembly 20 includes a housing 22 with an inner bore which extends along a central axis A from a closed first end 24 to an open second end 26. The housing 22 is preferably made as a monolithic piece of metal, such as steel or an alloy steel and may be shaped through any suitable process or combination of processes including, for example, casting, forging, and/or machining. In the exemplary embodiment, the housing 22 is swaged, or otherwise deformed, adjacent the open second end 26 to capture the below-discussed components within the inner bore of the housing 22.

The ball socket assembly 20 also includes a ball stud 28 and a bearing 30, which provides a low-friction interface between the housing 22 and the ball stud 28. The bearing 30 is located in the inner bore of the housing 22 and has a semi-spherically curved bearing surface 32, which surrounds a ball cavity of the bearing 30. The ball stud 28 has a ball portion 34 that is disposed in the ball cavity and has an outer surface that is in slidable contact with the curved bearing surface 32. More specifically, the bearing surface 32 is in slidable contact with both an upper hemisphere and a lower hemisphere of the ball portion 34. The outer surface of the ball portion 34 and the curved bearing surface 32 have similar radiuses of curvature, thereby allowing the ball stud 28 to freely articulate and rotate relative to the bearing 30 and housing 22. Although the bearing 30 is made of a low friction material as discussed in further detail below, friction between the curved bearing surface 32 and the ball portion 34 can be further reduced by packing the housing 22 with a lubricant, such as grease.

The ball stud 28 also has a shank portion 36, which extends out of the inner bore through the open second end 26 of the housing 22. The shank portion 36 has a neck region 38 with a reduced diameter adjacent the ball portion 34. The shank portion 36 tapers in a direction away from the ball portion 34 from the neck portion 38 to a greater diameter. The ball stud 28 is preferably made of a monolithic piece of metal, such as steel or an alloy steel. In some presently preferred embodiments, the ball stud 28 is made of SAE-AISI 4140 steel or 5140 steel.

The bearing 32 is generally cup shaped with a bottom 40 and a side wall 42. The curved bearing surface 32 is on the side wall 42, and the bottom 40 has an axially centrally located recessed area, which is not a part of the curved bearing surface 32, that serves as a lubricant reservoir. The side wall 42 also presents a plurality fingers 46 that are spaced circumferentially from one another by a plurality of slots 48 that extend from the open top of the bearing 30 towards the bottom 40. As discussed in further detail below, during assembly of the ball socket assembly 20, the fingers 46 flex outwardly to receive the ball portion 34 of the ball stud 28. In the exemplary embodiment, the bearing 30 has five fingers 46 and five slots 48. However it should be appreciated that the bearing 30 could have any suitable number of fingers 46 and slots 48.

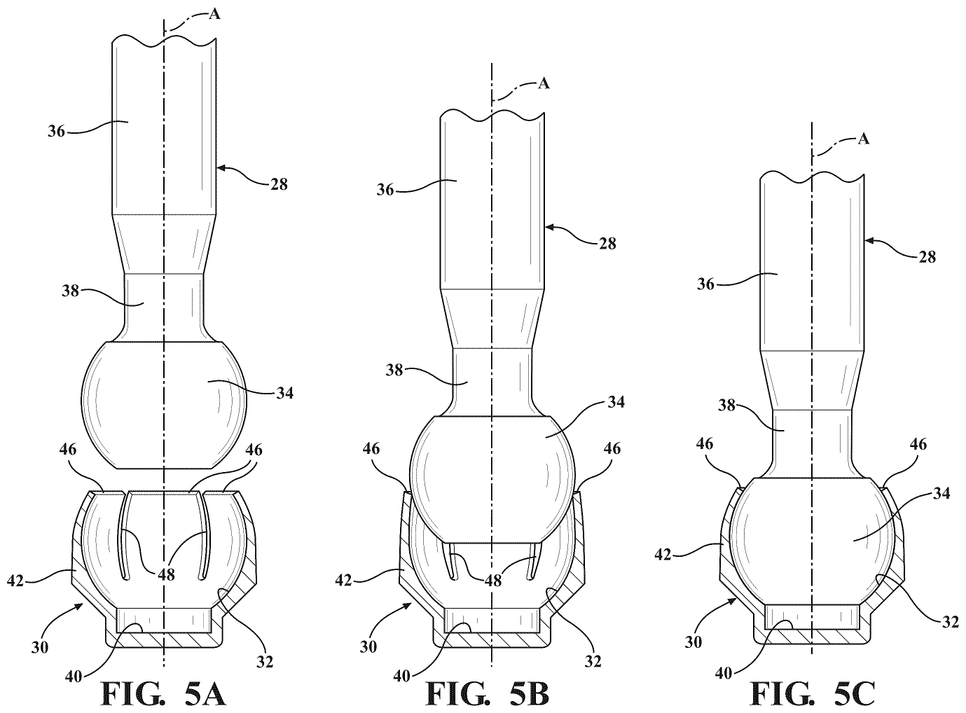

FIGS. 5A-C show the process of inserting the ball portion 34 of the ball stud 28 into the ball cavity of the bearing 30. In FIG. 5A, the bearing 30 is shown with the fingers 46 in a resting (unstressed) condition such that an open top of the bearing 30 has a smaller inner diameter than a diameter of an equator of the ball portion 34 of the ball stud 28. Referring now to FIG. 5B, the fingers 46 are elastically deflectable such that, when the ball portion 34 is urged against the open top of the bearing 30, the fingers 46 deflect radially outwardly to expand the inner diameter of the open top and allow an equator of the ball portion 34 to pass into the ball cavity. Referring now to FIG. 5C, once the equator clears the ends of the fingers 46, the fingers 46 spring inwardly to trap the ball portion 34 in the ball cavity. With the ball portion 34 in the ball cavity, the bearing 30 is once again in the resting condition. As shown, the curved bearing surface 32 has a radius of curvature which matches the radius of curvature of the ball portion 34 of the ball stud 28.

As also shown in FIGS. 5A-C, the slots 48 of the bearing 30 extend more than halfway from the open top to the bottom with the recessed area 40. Thus, when the ball portion 34 is received in the ball cavity, the slots 48 in the bearing 30 extend past the equator of the ball portion 34. Also, in this installed condition, the curved bearing surface 32 is in slidable contact with both hemispheres of the ball portion 34, i.e., both above and below the equator.

Once the ball portion 34 is trapped inside of the ball cavity of the bearing 30, the bearing 30 and ball portion 34 can then be inserted as a unit into the inner bore of the housing 22. In the exemplary embodiment, the open first end 24 of the housing 22 is then swaged inwardly to trap the bearing 30 and ball portion 34 in the open bore. The recessed area 40 of the bearing 30 functions as a lubricant reservoir to maintain a lubricant (such as grease) in the housing 22 to lubricate the surface-to-surface contact between the ball portion 34 of the ball stud 28 and the curved bearing surface 32 of the bearing 30.

In the exemplary embodiment, the plastic material of the bearing 30 comprises 8-12 mass percent polytetrafluoroethylene (PTFE), 2-6 mass percent carbon fibers, and the remainder polyoxymethylene (POM, also known as acetal, polyacetal, and polyformaldehyde). The bearing 30 is preferably made through an injection molding operation. This composition has been found to provide the bearing 30 with improved lubrication of the surface-to-surface contact between the ball portion 34 of the ball stud 28 and the curved bearing surface 32 while retaining both sufficient strength to transfer impact forces between the ball stud 28 and the housing 22 and sufficient flexibility of the fingers 46. In other words, the bearing 30 is both strong and the fingers 46 are flexible to resistant fracture during the process of inserting the ball portion 34 of the ball stud 28 into the ball cavity of the bearing 30.

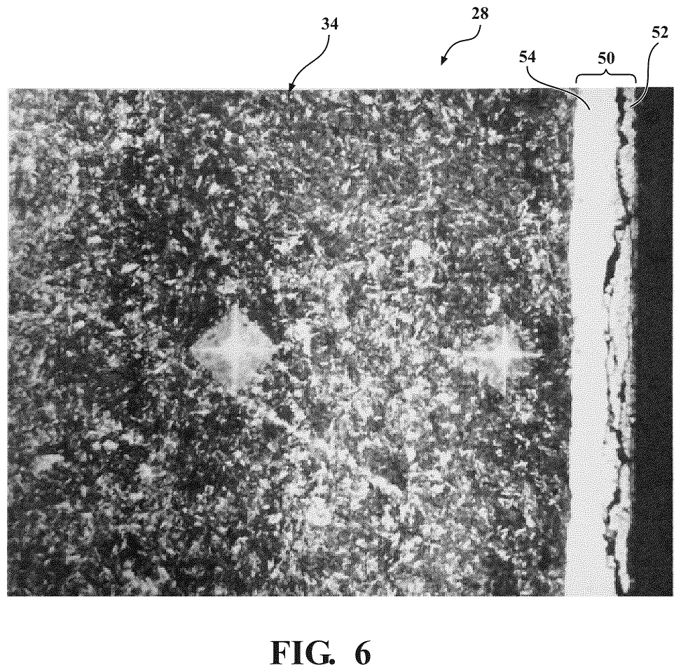

In an example embodiment, the ball stud 28 is constructed as a monolithic piece of metal, such as steel or an alloy steel. For example, in some embodiments, the ball stud 28 is constructed of SAE 5140 steel or SAE 4140 steel. The base steel material of the ball stud 28 is covered with a hardened coating or layer 50 to improve the hardness and strength of the ball stud 28. In the exemplary embodiments, the hardened layer 50 is a ferritic nitrocarburizing (FNC) layer or a Nitrox layer. FIG. 6 is a cross-sectional view illustrating the FNC layer 50 on an outer surface of an example ball stud 28. In this example, the FNC layer 50 has a total thickness of approximately 0.35 mm, which includes an oxide layer 52 and a compound “white” layer 54. In an example embodiment, the oxide layer 52 has a thickness of 2-3 μm and the white layer 54 has a thickness of 24-28 μm. In an example embodiment, the outer oxide layer 52 has a hardness of 750 HV. The FNC layer 50 improves the surface hardness, corrosion resistance, fatigue life, friction, and surface quality of the ball stud 52, thereby increasing its operating life.

The first step of applying the FNC layer 50 (also referred to as a Nitrox layer) to the ball stud 28 is to subject the ball stud 28 to a gas nitration operation. The gas nitration process is typically performed in an oven that is maintained at a temperature of around five hundred to five hundred and fifty degrees Celsius (500-550° C.). Two zones are formed in the Nitride layer: the compound layer (the white layer) 54 and a diffusion layer with dissolved nitrogen and hard nitride precipitates. By controlling the atmosphere in the oven (including, for example, nitrogen content, temperature, and bake time), the properties of the FNC layer 50 can be adjusted to impute desired properties in the ball stud 28. After the gas nitration process, the ball stud 28 is subjected to an oxidation process to form the oxide layer 52 of iron oxide (Fe₃O₄) on the outermost surface of the ball stud 28. Thus, the FNC layer 50 has varying properties at different depths within the ball stud 28 including an extremely hard outermost surface and a more durable region beneath the outermost surface.

In some cases, the FNC layer 50 has been found to improve the strength of the ball stud 28 by over sixty percent (60%). For example, in one test, a ball stud 28 made of SAE 5140 steel and having an FNC layer 50 applied thereto was tested to have a tensile strength of 65,000 psi whereas a similarly constructed ball stud without the FNC layer has been found to exhibit a tensile strength of 40,000 psi. Similarly, in another test, a ball stud 28 made of SAE 4140 steel and having an FNC layer 50 applied thereto was tested to have a tensile strength of 70,000 psi whereas a similarly constructed ball stud without the FNC layer has been found to exhibit a tensile strength of 55,000 psi. Thus, the FNC layer 50 significantly improves the strength of the ball stud 28.

The unique combination of the bearing 30 being made of a material that includes 8-12 mass percent PTFE, 2-6 mass percent carbon fibers, and the remainder of POM and the SAE 4140 or 5140 steel ball stud 28 with the hardened layer 50 has been found to greatly improve the operating life of the ball socket assembly 20.

In one example embodiment, the FNC layer 50 is applied to an entire outer surface of the ball stud 28, including over both the ball portion 34 and the shank portion 36. In some embodiments, the FNC layer 50 can be applied to only a portion of the ball stud 28, e.g., only the semi-spherically curved region of the ball portion 34 of the ball stud 28. By applying the FNC layer 50 to the entire outer surface of the ball stud 28, the corrosion resistance of the shank portion 36, which may be exposed to corrosive elements, may be greatly improved. In some tests, the presence of the FNC layer 50 on the outer surface of a ball stud 28 can reduce corrosion by up to 75% as compared to a control ball stud that lacks the FNC layer but is otherwise identical to the ball stud 28. According to yet another embodiment, the FNC layer 50 is applied to a neck region or undercut and taper region that is located between the ball portion 34 and the shank portion 36. The FNC layer 50 significantly improves the strength of the ball stud 28 in this region and the ball portion 34 is uncoated.

During operation of the exemplary embodiment of the ball socket assembly 20, the only sliding movement between any two surfaces is the sliding movement between the FNC layer of the ball portion 34 of the ball stud 28 and the aforementioned and unique plastic material of the bearing 30, i.e., all other surface-to-surface interfaces are static rather than dynamic. This unique combination has been found to provide the ball socket assembly 20 with both exceptional performance and wear resistance as compared to other known ball socket assemblies with either other bearing compositions and/or ball studs without the FNC layer.

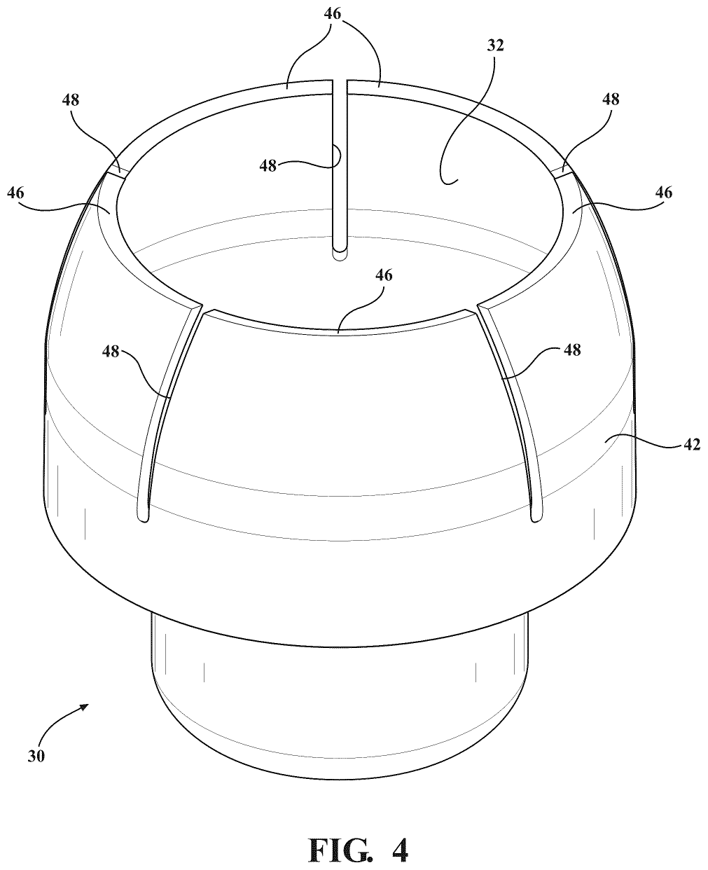

Another aspect of the present invention is related to a method of making a ball socket assembly 20, such as the ball socket assembly 20 described above and shown in FIGS. 1-5. The method includes the step of forming a ball stud 28 out of metal. The method proceeds with the step of applying a FNC layer 50 to at least a portion of an outer surface of the ball stud 28. The method includes the step of preparing the bearing 30. The method proceeds with the step of urging a ball portion 34 of a ball stud 28 towards the ball cavity. The method continues with the step of deflecting the fingers 46 in a radially outward direction to allow the ball portion 34 of the ball stud 28 to pass the ends of the fingers 46 and be received in the ball cavity. The method proceeds with the step of inserting the bearing 30, with the ball portion 34 contained in the ball cavity, into the open bore of the housing 22.

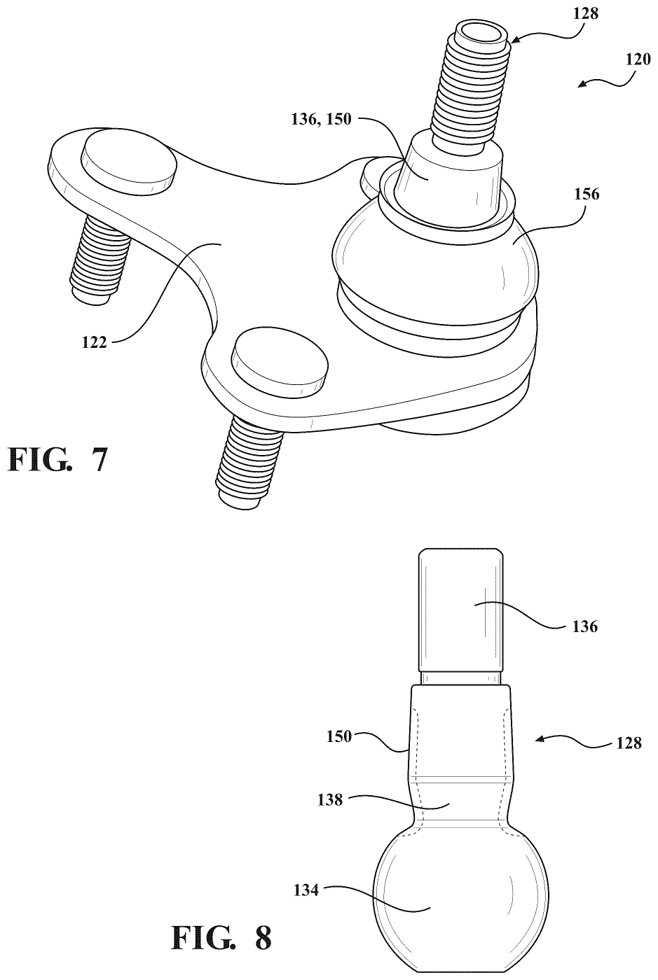

Turning now to FIG. 7, a second exemplary embodiment of the ball socket assembly 120 is illustrated with like numerals, separated by a prefix of “1,” identifying like components with the first embodiment described above. In this embodiment, the ball socket assembly 120 is a ball joint for connecting a control arm of a suspension assembly with a knuckle.

In this example embodiment, the hardened layer 150 is only applied to the ball stud along a top area of the ball portion 134 and through a neck region 138 of the shank portion 136. The hardened layer 150 stops short of the threads at the end of the shank portion 136. Thus, in this embodiment, the hardened layer 150 is applied to only a portion of the outer surface of the ball stud 128.

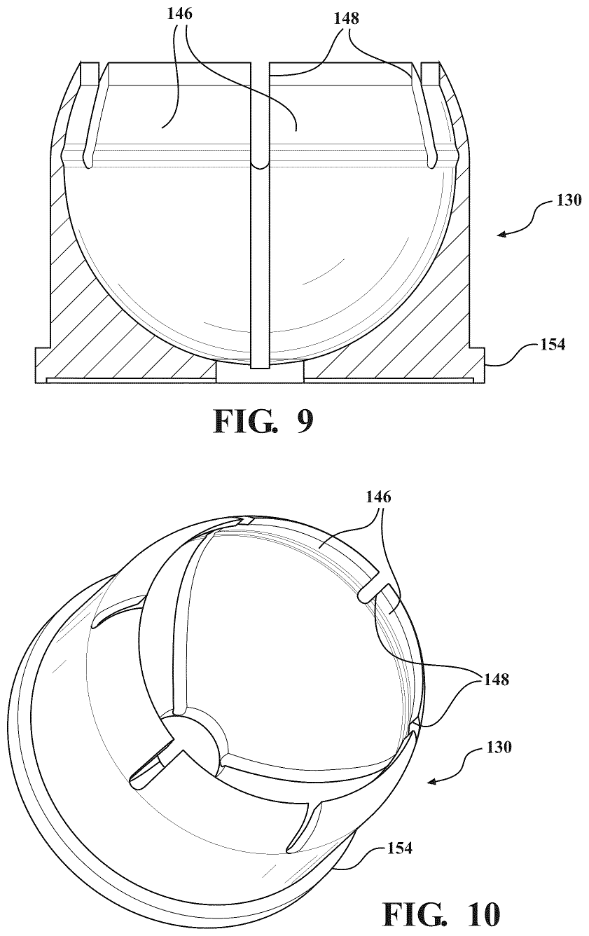

The bearing 130 of the second embodiment is illustrated in FIG. 9. In this embodiment, the slots 148 that separate the fingers 146 only extend to an equator of the ball cavity, which receives the ball portion 134 of the ball stud 128. Below the equator, the wall thickness of the bearing 130 increases towards a lower end that defines a radially outwardly extending flange 154.

A process of assembling the ball socket assembly 120 of the second embodiment begins with coating the ball portion 134 of the ball stud 128 with a grease and then pressing the ball portion 134 into the ball cavity of the bearing 130. During the pressing process, the fingers 146 will deflect elastically to allow the ball portion 134 to pass through the open end of the bearing 130. Next, the bearing 130, with the ball stud 128 captured therein, is inserted into the housing 122 through an open end of the housing 122. An end of the housing 122 is then swaged, or spun, to capture the bearing 130 in the housing 122. A boot 156 is next sealed against the housing 122 and the shank portion 138 of the ball stud with a pair of clamping rings. In the exemplary embodiment, the boot 156 seals directly against the hardened layer 150.

Obviously, many modifications and variations of the present invention are possible in light of the above teachings. It is, therefore, to be understood that within the scope of the appended claims, the invention may be practiced otherwise than specifically described. Additionally, it is to be understood that all features of all claims and all embodiments can be combined with each other, as long as they do not contradict each other.

What is claimed is:

1. A ball socket assembly, comprising:
a housing with an inner bore;
a bearing received in said inner bore of said housing, said bearing being made as a monolithic piece of a plastic material, and said bearing having a curved bearing surface which surrounds a ball cavity;
a ball stud having a ball portion and a shank portion, said ball portion being received in said ball cavity of said bearing, and said ball portion having an equator;
said curved bearing surface of said bearing being in slidable contact with said ball portion of said ball stud on opposite axial sides of said equator;
said plastic material of said bearing comprising 8-12 mass percent polytetrafluoroethylene, 2-6 mass percent carbon fibers, and the remainder acetal; and
said ball stud having a hardened layer along at least a portion of its outer surface, the hardened layer being a Nitrox layer.

2. The ball socket assembly as set forth in claim 1, wherein an entire outer surface of the ball stud includes the hardened layer.

3. The ball socket assembly as set forth in claim 2, wherein the ball stud includes a base material that is of an SAE-AISI 4140 steel or an SAE-AISI 5140 steel.

4. The ball socket assembly as set forth in claim 1, wherein said hardened layer includes an oxide zone and a compound zone.

5. The ball socket assembly as set forth in claim 4, wherein said oxide zone of the hardened layer has a thickness that is in the range of 2-3 μm

6. The ball socket assembly as set forth in claim 5, wherein said compound zone of said hardened layer has a thickness in the range of 24-28 μm.

7. The ball socket assembly as set forth in claim 1, wherein said bearing includes a plurality of fingers that are spaced apart from one another by a plurality of slots and wherein said fingers can flex outwardly when inserting said ball portion of said ball stud into a ball cavity of said bearing.

8. The ball socket assembly as set forth in claim 1, wherein said bearing surface of said bearing is in contact with both an upper hemisphere and a lower hemisphere of said ball portion of said ball stud.

9. The ball socket assembly as set forth in claim 1, wherein said bearing includes a recessed area.

10. A method of making a ball socket assembly, comprising the steps of:
forming a ball stud out of metal, the ball stud having a ball portion and a shank portion;
applying a Nitride layer to at least a portion of an outer surface of the ball stud;
forming a bearing that has a curved bearing surface of a plastic material that comprises 8-12 mass percent polytetrafluoroethylene, 2-6 mass percent carbon fibers, and the remainder acetal; and
inserting the bearing and the ball stud into a housing with an outer surface of the ball stud being in slidable contact with the curved bearing surface of the bearing.

11. The method as set forth in claim 10, wherein the step of applying the Nitrox layer to the ball stud includes subjecting the ball stud to a gas nitriding operation to form a compound zone and then subjecting the ball stud to an oxidation process to form an oxide zone.

12. The method as set forth in claim 11, wherein the compound zone of the Nitride layer has a thickness in the range of 24-28 μm.

13. The method as set forth in claim 12, wherein the oxide zone of the Nitride layer has a thickness in the range of 2-3 μm.

14. The method as set forth in claim 10, wherein the step of applying the Nitrox layer to the ball stud includes applying the Nitrox layer to an entire outer surface of the ball stud.

15. The method as set forth in claim 10, wherein the bearing includes a plurality of fingers that surround a ball cavity and are spaced apart from one another by a plurality of slots that extend form an open end of the bearing.

16. The method as set forth in claim 15, further including the step of deflecting the fingers of the bearing while inserting the ball portion of the ball stud into the ball cavity of the bearing.

17. The method as set forth in claim 16, wherein the curved bearing surface of the bearing is in slidable contact with an upper hemisphere of the ball portion of the ball stud and a lower hemisphere of the ball portion of the ball stud.

18. The method as set forth in claim 10, wherein the metal of the ball stud is SAE-AISI 4140 steel or is SAE-AISI 5140 steel.

19. A method of making a ball socket assembly, comprising the steps of:
forming a ball stud out of SAE-AISI 4140 steel or SAE-AISI 5140 steel, the ball stud having a ball portion and a shank portion;
subjecting the ball stud to a gas nitration operation in an oven to create a zone in the ball stud that has dissolved nitrogen and hard nitrogen precipitates;
subjecting the ball stud to an oxidation process to form a zone in the ball stud that has Fe₃O₄.
forming a bearing that has a curved bearing surface of a plastic material that comprises 8-12 mass percent polytetrafluoroethylene, 2-6 mass percent carbon fibers, and the remainder acetal; and
inserting the bearing and a portion of the ball stud into a housing with an outer surface of the ball stud being in slidable contact with the curved bearing surface of the bearing.

20. The method as set forth in claim 19, wherein the oven is set at a temperature of between five hundred and five hundred and fifty degrees Celsius (500-550° C.).
